(19) United States
(12) Patent Application Publication
(10) Pub. No.: US 2015/0242014 A1
(43) Pub. Date: Aug. 27, 2015

(54) TOUCH PANEL AND METHOD OF MANUFACTURING THE SAME

(71) Applicant: SAMSUNG ELECTRONICS CO., LTD., Suwon-si (KR)

(72) Inventors: Young Mo KANG, Seoul (KR); Joo-won LEE, Suwon-si (KR); Il-yong JUNG, Yongin-si (KR)

(73) Assignee: SAMSUNG ELECTRONICS CO., LTD., Suwon-si (KR)

(21) Appl. No.: 14/475,753

(22) Filed: Sep. 3, 2014

(30) Foreign Application Priority Data
Feb. 24, 2014 (KR) 10-2014-0021206

(51) Int. Cl. G06F 3/044

(52) U.S. Cl. CPC G06F 3/044; G06F 2203/04112; G06F 2203/04103

(57) ABSTRACT

A touch panel and a method of manufacturing the touch panel are provided. The touch panel includes: a first conductive substrate configured to form a plurality of first electrode lines on the first conductive substrate; and a second conductive substrate configured to form a plurality of second electrode lines in a direction crossing the plurality of first electrode lines on the second conductive substrate. The plurality of first electrode lines are respectively formed in a first area that is set to keep intervals between the plurality of first electrode lines irregular, and the plurality of second electrode lines are respectively formed in a second area that is set to keep intervals between the plurality of second electrode lines irregular.

### CROSS-REFERENCE TO RELATED APPLICATION

This application claims priority from Korean Patent Application No. 10-2014-0021206, filed on Feb. 24, 2014, in the Korean Intellectual Property Office, the disclosure of which is incorporated herein by reference in its entirety.

### BACKGROUND

1. Field

Apparatuses and methods consistent with the exemplary embodiments relate to a touch panel and a method of manufacturing the same, and more particularly, to providing a touch panel having a translucent characteristic and a method of manufacturing the same.

2. Description of the Related Art

In general, a touch panel is classified as a resistive touch panel, a capacitive touch panel, an infrared touch panel, an ultrasonic touch panel, etc. according to the sensing method of the touch panel. Among these methods, the capacitive touch panel is currently widely used. In the capacitive touch panel, a plurality of electrode lines are arrayed in column and row directions to constitute virtual coordinates. Therefore, if a user touches a particular area of the capacitive touch panel, the capacitive touch panel may sense variations in a capacitance of an electrode line corresponding to one of the virtual coordinates corresponding to the touched area in order to detect the particular area touched by the user.

The capacitive touch panel forms patterns of the electrode lines by using a touch screen panel (TSP) technology. In TSP technology, electrode lines are arrayed in the column direction and electrode lines are arrayed in the row direction at regular intervals. As the electrode lines in the column and row directions are arrayed at regular intervals when using the TSP technology, the electrode lines reflect transmitted light or interrupt the transmission of light and optically cause diffraction and a Moire phenomena. Also, if these electrodes are formed on the touch panel, Moire patterns are formed on the touch panel due to an interference phenomenon with a black matrix which forms display pixels.

In particular, if the electrode lines are formed at regular intervals by using a metal mesh method, the corresponding electrode lines are formed of a metal material. Therefore, the reflectance of light is increased by the electrode lines, and thus diffraction and Moire phenomena are noticeable due to an interference phenomenon of light.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

The exemplary embodiments provide a touch panel that improves a diffraction phenomenon and a Moire phenomenon occurring due to an interference phenomenon of light caused by electrode lines having lattice shapes, and a method of manufacturing the same.

According to an aspect of the exemplary embodiments, there is provided a touch panel including: a first conductive substrate configured to form a plurality of first electrode lines on the first conductive substrate; and a second conductive substrate configured to form a plurality of second electrode lines in a direction crossing the plurality of first electrode lines on the second conductive substrate. The plurality of first electrode lines may be respectively formed in a first area that is set to keep intervals between the plurality of first electrode lines irregular, and the plurality of second electrode lines may be respectively formed in a second area that is set to keep intervals between the plurality of second electrode lines irregular.

The first and second areas may be areas that are set within periods at which the plurality of first electrode lines and the plurality of second electrode lines have regular intervals.

An average interval of the plurality of first electrode lines and an average interval the plurality of second electrode lines may correspond to the periods at which the plurality of first electrode lines and the plurality of second electrode lines, respectively, have the regular intervals.

The plurality of first electrode lines are formed in the first area based on coordinate values calculated from Equation 1 and the plurality of second electrode lines may be formed in the second area based on coordinate values calculated from Equation 2 below:

xₙ={(2*n−1)/2}*Pₓ+X*Px*Uₙ [Equation 1]

yₙ={(2*n−1)/2}*P_{y}+Y*P_{y}*Uₙ [Equation 2]

wherein n denotes an index value of each of the first electrode lines and the second electrode lines, Pₓ and P_{y} denote periods having regular intervals, X and Y denote values that are set to keep minimum intervals of the plurality of first electrode lines and the plurality of second electrode lines, respectively, and Uₙ denotes a random value between 0 and 1.

The values X and Y that are set to keep the minimum intervals of the plurality of first electrode lines and the plurality of second electrode lines, respectively, may be calculated from Equation 3 and Equation 4, respectively below:

X=L/Pₓ [Equation 3]

Y=L/P_{y} [Equation 4]

wherein L in Equation 3 denotes a length value of the first area, and wherein L in Equation 4 denotes a length value of the second area.

The plurality of first electrode lines and the plurality of second electrode lines may be formed on the first conductive substrate and the second conductive substrate, respectively, through a metal mesh method.

The plurality of first electrode lines and the plurality of second electrode lines may be respectively formed of at least one metal material of gold (Au), silver (Ag), copper (Cu), aluminum (Al), tin (Sn), nickel (Ni), chrome (Cr), titanium (Ti), molybdenum (Mo), zinc (Zn), and iron (Fe) or an alloy including at least one of Au, Ag, Cu, Al, Sn, Ni, Cr, Ti, Mo, Zn, and Fe.

According to another aspect of the exemplary embodiments, there is provided a method of manufacturing a touch panel. The method may include: forming a first conductive substrate on which a plurality of first electrode lines are formed; and stacking a second conductive substrate on which a plurality of second electrode lines are formed in a direction crossing the plurality of first electrode lines. The plurality of first electrode lines may be respectively formed in a first area that is set to keep intervals between the plurality of first electrode lines irregular, and the plurality of second electrode lines may be respectively formed in a second area that is set to keep intervals between the plurality of second electrode lines irregular.

The first area and the second area may be areas that are set within periods at which the plurality of first electrode lines and the plurality of second electrode lines, respectively, have regular intervals.

An average interval of the plurality of first electrode lines and an average interval of the plurality of second electrode lines may correspond to the periods at which the plurality of first electrode lines and the plurality of second electrode lines, respectively, have the regular intervals.

The plurality of first electrode lines may be formed in the first area based on coordinate values calculated from Equation 1, and the plurality of second electrode lines may be formed in the second area based on coordinate values calculated from Equation 2 below:

xₙ={(2*n−1)/2}*Pₓ+X*Px*Uₙ [Equation 1]

yₙ={(2*n−1)/2}*P_{y}+Y*P_{y}*Uₙ [Equation 2]

wherein n denotes an index value of each of the first electrode lines and the second electrode lines, Pₓ and P_{y} denote periods having regular intervals, X and Y denote values that are set to keep minimum intervals of the plurality of first electrode lines and the plurality of second electrode lines, respectively, and Uₙ denotes a random value between 0 and 1.

The values X and Y that are set to keep the minimum intervals of the plurality of first electrode lines and the plurality of second electrode lines, respectively, may be calculated from Equation 3 and Equation 4, respectively below:

X=L/Pₓ [Equation 3]

Y=L/P_{y} [Equation 4]

wherein L in Equation 3 denotes a length value of the first area, and wherein L in Equation 4 denotes a length value of the second area.

The plurality of first electrode lines and the plurality of second electrode lines may be formed on the first conductive substrate and the second conductive substrate through a metal mesh method.

The plurality of first electrode lines and the plurality of second electrode lines may be respectively formed of at least one metal material of gold (Au), silver (Ag), copper (Cu), aluminum (Al), tin (Sn), nickel (Ni), chrome (Cr), titanium (Ti), molybdenum (Mo), zinc (Zn), and iron (Fe) or an alloy including at least one of Au, Ag, Cu, Al, Sn, Ni, Cr, Ti, Mo, Zn, and Fe.

### BRIEF DESCRIPTION OF THE DRAWINGS

The above and/or other aspects will be more apparent by describing certain exemplary embodiments with reference to the accompanying drawings, in which:

FIG. 1 is a view illustrating a display apparatus according to an exemplary embodiment;

FIG. 2 is a block diagram of a display apparatus according to an exemplary embodiment;

FIG. 3 is an exploded perspective view of a touch panel according to an exemplary embodiment;

FIG. 4 is a view illustrating a plurality of first electrode lines that are formed on a first conductive substrate at irregular intervals, according to an exemplary embodiment;

FIG. 5 is a view illustrating a plurality of second electrode lines that are formed on a second conductive substrate at irregular intervals, according to an exemplary embodiment;

FIG. 6 is a graph illustrating a simulation result showing a reflectance of light occurring through a plurality of electrode lines on a touch panel, according to an exemplary embodiment; and

FIG. 7 is a flowchart of a method of manufacturing a touch panel, according to an exemplary embodiment.

### DETAILED DESCRIPTION OF THE EXEMPLARY EMBODIMENTS

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

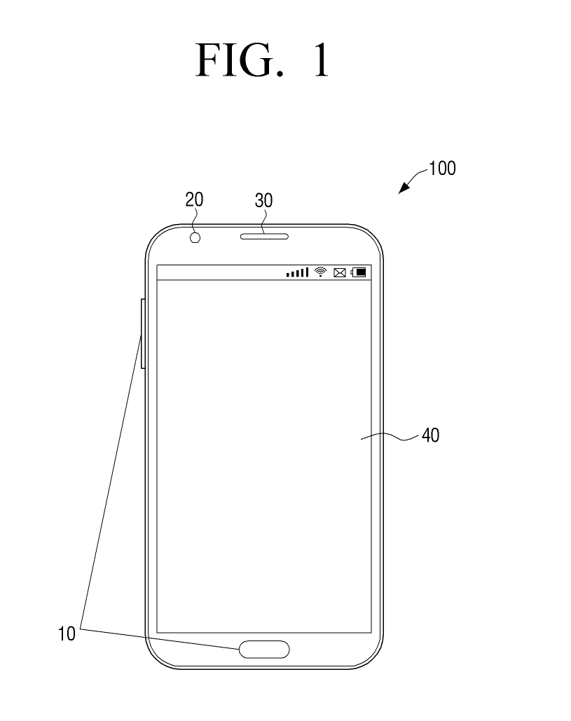

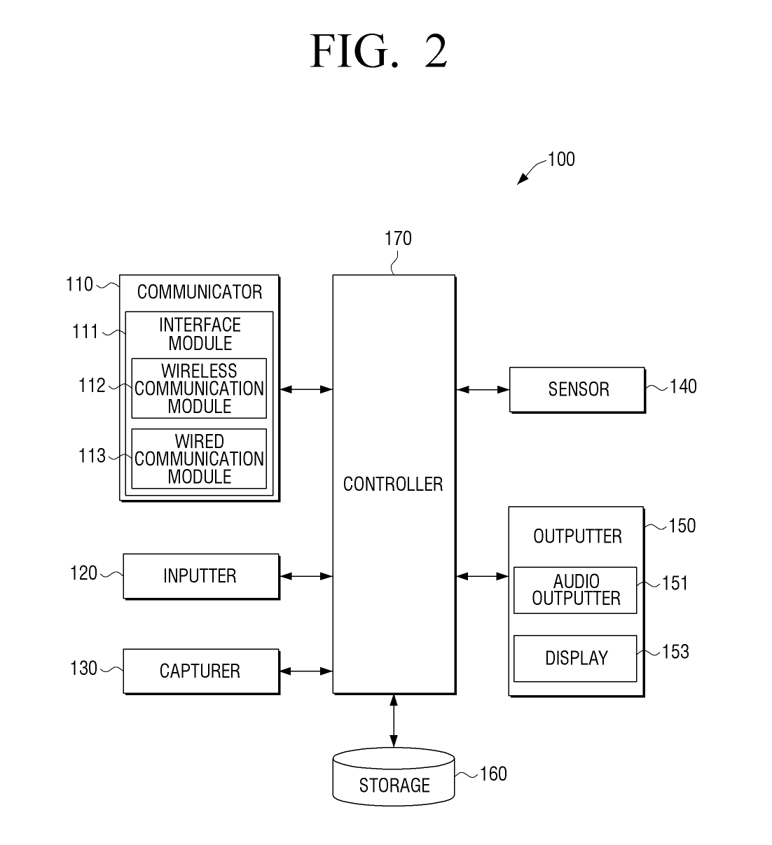

FIG. 1 is a view illustrating a display apparatus 100 according to an exemplary embodiment. FIG. 2 is a block diagram of the display apparatus 100, according to an exemplary embodiment.

Referring to FIG. 1, the display apparatus 100 includes a touch panel 40 having one or more touch screens and executes an application or displays contents. Examples of the display apparatus 100 may include a tablet personal computer (PC), a portable multimedia player (PMP), a personal digital assistant (PDA), a smartphone, a portable phone, a digital frame, etc. Referring to FIG. 2, the display apparatus 100 includes a communicator 110, an inputter 120, a capturer 130, a sensor 140, an outputter 150, a storage 160, and a controller 170.

The communicator 110 performs data communication with an external server (not shown) or an external terminal apparatus (not shown) via wire or wirelessly. According to exemplary embodiments, the communicator 110 may include an interface module 111 that includes at least one of a wireless communication module 112, such as a cellular communication module, a wireless local area network (WLAN) module, a short-range communication module, a global positioning system (GPS) communication module, a broadcasting communication module, or the like, and a wired communication module 113, such as a high definition multimedia interface (HDMI), a universal serial bus (USB), an Institute of Electrical and Electronics Engineers (IEEE) 1394, or the like.

Here, the cellular communication module uses a wireless access technology complying with a cellular communication protocol according to a control command of the controller 170 in order to connect the display apparatus 100 to an external apparatus (not shown) through at least one antenna (not shown) or a plurality of antennas (not shown). The cellular communication module may also transmit and/or receive a voice call, a video call, a short messaging service (SMS) message, or a multimedia message service (MMS) message with another communicable apparatus such as a portable phone, a smartphone, a tablet PC, another device, or the like having a phone number input into the display apparatus 100.

The WLAN module is an element that accesses an access point (AP) (not shown) existing within a preset range so as to be connected to the Internet according to a control command of the controller 170. The WLAN module supports IEEE802.11x of IEEE.

The short-range communication module is an element that wirelessly performs a short-range communication between the display apparatus 100 and the external apparatus according to the control command of the controller 170. The short-range communication module may include at least one of a Bluetooth module, an infrared data association (IrDA) module, a near field communication (NFC) module, a WIFI module, and a Zigbee module.

The communicator 110 may be realized according to various types of short-range communication methods as described above and may use other communication technologies that are mentioned in the exemplary embodiments.

The interface module 111 is an element that performs data communication with various types of apparatuses such as USB 2.0, USB 3.0, an HDMI, IEEE 1394, etc. In detail, the interface module 111 may transmit data stored in the storage 160 of the display apparatus 100 to the external apparatus through a wired cable or may receive data from the external apparatus through the wired cable.

The GPS module may calculate a position of the display apparatus 100 by using a time of arrival which is based on the amount of time that is taken until a signal propagated from GPS satellites reaches the display apparatus 100 and GPS parameters based on a signal propagated from a plurality of GPS satellites on the earth orbit.

The broadcasting communication module may receive a broadcast signal (e.g., a TV broadcast signal, a radio broadcast signal, or a data broadcast signal) and broadcast additional information (e.g., an electric program guide (EPG) or an electric service guide (ESG)) from a broadcasting station through a broadcasting communication antenna (not shown) according to the control command of the controller 170.

As shown in FIG. 1, the inputter 120 receives an input signal from operators 10 or an inputter of the touch panel 40 and transmits the input signal to the controller 170.

The capturer 130 transmits image data, which is captured through a camera 20 installed in a housing of the display apparatus 100, to the controller 170 according to the control command of the controller 170. Here, the camera 20 installed in the housing of the display apparatus 100 may be arranged in at least one of a front surface and a back surface of the display apparatus 100 to capture an image. The camera 20 may also include a lens unit (not shown), an aperture (not shown), a charge-coupled device (CCD) image sensor (not shown), and an analog-to-digital converter (ADC). The camera 20 which is used can be based on well-known technology, and thus a detailed description thereof is omitted.

The sensor 140 senses various status changes, such as a user touch on the display apparatus 100, a user motion, a motion of the display apparatus 100, etc. According to an exemplary embodiment, the sensor 140 may include at least one of a touch sensor, a geomagnetic sensor, an acceleration sensor, and a proximity sensor.

The touch sensor senses a touch made by a user on the touch panel 40 of the display apparatus 100 and may be realized as a capacitive touch sensor according to exemplary embodiments. The geomagnetic sensor detects a flow of a magnetic field to sense an azimuth. In detail, the geomagnetic sensor may detect a bearing coordinate of the display apparatus 100 and detect a direction in which the display apparatus 100 is placed, based on the detected bearing coordinate. The acceleration sensor may detect an acceleration of the display apparatus 100, set virtual x, y, and z axes on the display apparatus 100, and detect a gravity acceleration value that varies according to slopes of the virtual x, y, and z axes.

The proximity sensor senses whether an object approaches the display apparatus 100. For example, the proximity sensor may receive a touch command of the user through only a motion of the user who approaches a screen of the touch panel 40 with a finger or other objects without directly touching the screen of the touch panel 40.

The outputter 150 may include an audio outputter 151 and a display 153 and may output audio data and image data through the audio outputter 151 and the display 153. In detail, the audio outputter 151 outputs audio data corresponding to contents, such as a broadcast signal, a digital audio file, a digital video file, etc., or audio data (e.g., a button control sound, a ring back tone, etc.) corresponding to a function that may be performed by the display apparatus 100, as an audible sound through a speaker 30 according to the control command of the controller 170.

The display 153 is an element that displays various types of data and contents on the screen according to the control command of the controller 170 and may be formed into a single body along with the touch panel 40 for receiving the touch command of the user. Therefore, the display 153 may display various types of data and contents, which are processed according to the control command of the controller 170, on the screen and receive the touch command of the user through the touch panel 40. The touch panel 40 that receives the touch command of the user will be described in more detail later.

The storage 160 is an element that stores data. According to exemplary embodiments, the storage 160 stores various types of application programs that execute an operation of the display apparatus 100 and provide a user interface (UI) by using an operating system (OS) for controlling the operation of the display apparatus 100 and resources of the OS. The storage 160 may also store various types of multimedia data and content data processed according to the control command of the controller 170 and data received from an external source. The storage 160 may be realized as at least one of a memory card (e.g., a secure digital (SD) card, a memory stick, or the like), a nonvolatile memory, a volatile memory, a hard disk drive (HDD), and a solid state drive (SSD) that may be removably installed in the display apparatus 100.

The controller 170 controls the elements of the display apparatus 100 described above. The controller 170 may include a central processing unit (CPU), a graphic processing unit (GPU), a random access memory (RAM), a read only memory (ROM), and a system bus in terms of hardware. The controller 170 may include an OS for driving a corresponding hardware configuration and an application that provides a UI on the OS to transmit the UI to a framework, in terms of software. A hardware configuration or a software configuration of the controller 170 is well-known technology, and thus a detailed description thereof is omitted.

The overall elements of the display apparatus 100 enabling a touch input according to an exemplary embodiment have been described. The touch panel 40 of the display apparatus 100 according to an exemplary embodiment will now be described in detail.

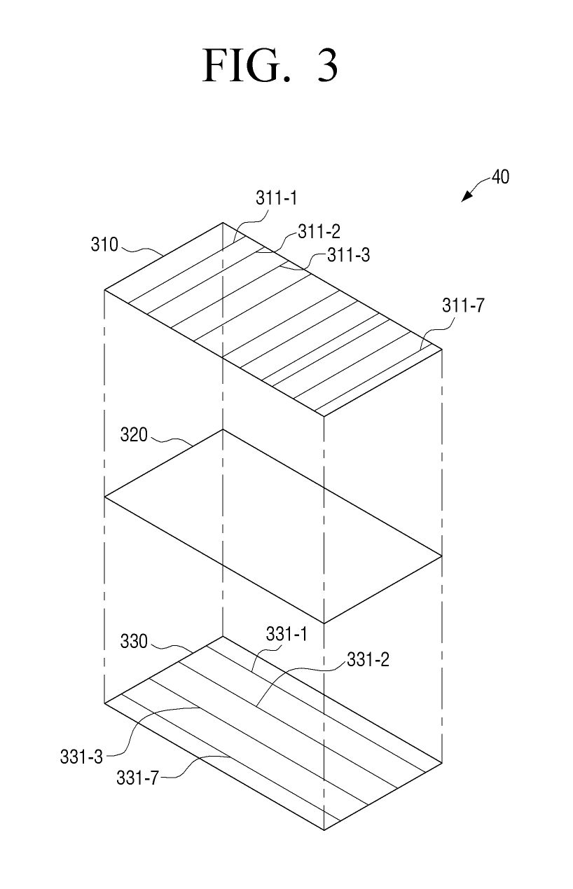

FIG. 3 is an exploded perspective view of the touch panel 40, according to an exemplary embodiment.

The exemplary embodiment provides a technology for preventing a diffraction phenomenon and a Moire phenomenon, which occurs due to existing regular electrode patterns, through only changes of the electrode patterns without changing a circuit configuration of the touch panel 40. Therefore, electrode patterns of the touch panel 40 of an exemplary embodiment will be described in detail.

As shown in FIG. 3, the touch panel 40 includes a first conductive substrate 310 and a second conductive substrate 330. An insulating layer 320 may be formed between the first conductive substrate 310 and the second conductive substrate 330. In detail, the first conductive substrate 310 is formed so as to array a plurality of first electrode lines 311-1 through 311-n at irregular intervals in a vertical direction. The second conductive substrate 330 is formed so as to array a plurality of second electrode lines 331-1 through 331-n at irregular intervals in a horizontal direction. Here, the first electrode lines 311-1 through 311-n formed at the irregular intervals on the first conductive substrate 310 and the second electrode lines 331-1 through 331-n formed at the irregular intervals on the second conductive substrate 330 may be formed of at least one metal material of gold (Au), silver (Ag), copper (Cu), aluminum (Al), nickel (Ni), chrome (Cr), titanium (Ti), molybdenum (Mo), zinc (Zn), and iron (Fe) or an alloy including them.

The plurality of first electrode lines 311-1 through 311-n and the plurality of second electrode lines 331-1 through 331-n may be respectively formed on the first and second conductive substrates 310 and 330, respectively, through a metal mesh method.

In detail, the plurality of first electrode lines 311-1 through 311-n formed on the first conductive substrate 310 are formed in a preset first area to have irregular intervals. The plurality of second electrode lines 331-1 through 331-n formed on the second conductive substrate 330 are formed in a preset second area to have irregular intervals. Here, the first area that is preset so as to form the plurality of first electrode lines 311-1 through 311-n at the irregular intervals is set within a period on which the plurality of first electrode lines 311-1 through 311-n have regular intervals. Also, the second area that is preset so as to form the plurality of second electrode lines 331-1 through 331-n at the irregular intervals is set within a period on which the plurality of second electrode lines 331-1 through 331-n have regular intervals.

An average interval of each of the plurality of electrode lines 311-1 through 311-n formed at the irregular intervals on the first conductive substrate 310 may correspond to the period on which the plurality of first electrode lines 311-1 through 311-n formed on the first conductive substrate 310 have the regular intervals. Also, an average interval of each of the plurality of second electrode lines 331-1 through 331-n formed at the irregular intervals on the second conductive substrate 330 may correspond to the period on which the plurality of second electrode lines 331-1 through 331-n formed on the second conductive substrate 330 have the regular intervals.

As described above, in the touch panel 40 according to the exemplary embodiment, the plurality of first electrode lines 311-1 through 311-n and the plurality of second electrode lines 331-1 through 331-n may be formed at the irregular intervals on the first and second conductive substrates 310 and 330 without changing a design of a circuit configuration for detecting variations in a capacitance caused by a touch input of the user. Therefore, the touch panel 40 according to an exemplary embodiment resolves a diffraction phenomenon problem.

Each of the first electrode lines 311-1 through 311-n formed on the first conductive substrate 310 may be drawn from Equation 1 below:

xₙ={(2*n−1)/2}*Pₓ+X*Px*Uₙ [Equation 1]

wherein n denotes an index value of each of the first electrode lines 311-1 through 311-n, Pₓ denotes a period in which the first electrode lines 311-1 through 311-n have regular intervals, X denotes a value that is set to keep minimum intervals of the plurality of first electrode lines 311-1 through 311-n, and Uₙ denotes a random value that is generated between values 0 and 1 through a random function algorithm.

Each of the second electrode lines 331-1 through 331-n formed on the second conductive substrate 330 may be drawn from Equation 2 below:

yₙ={(2*n−1)/2}*P_{y}+Y*P_{y}*Uₙ [Equation 2]

wherein n denotes an index value of each of the second electrode lines 331-1 through 331-n, P_{y} denotes the period in which the second electrode lines 331-1 through 331-n have the regular intervals, Y denotes a value that is set to keep minimum intervals of the plurality of second electrode lines 331-1 through 331-n, and Uₙ denotes a random value that is generated between values 0 and 1 through a random function algorithm.

The values X and Y that are set to keep the minimum intervals of the first electrode lines 311-1 through 311-n and the second electrode lines 331-1 through 331-n in Equations 1 and 2 above may be respectively drawn from Equations 3 and 4:

X=L/Pₓ [Equation 3]

Y=L/P_{y} [Equation 4]

wherein L denotes a length value of each of the preset first area and the preset second area, and Pₓ and P_{y} respectively denote the periods in which the first electrode lines 311-1 through 311-n and the second electrode lines 331-1 through 331-n have the regular intervals as described above.

The plurality of first electrode lines 311-1 through 311-n and the plurality of second electrode lines 331-1 through 331-n that are formed at the irregular intervals on the first conductive substrate 310 and the second conductive substrate 330 based on Equations 1 through 4 above will now be described in detail.

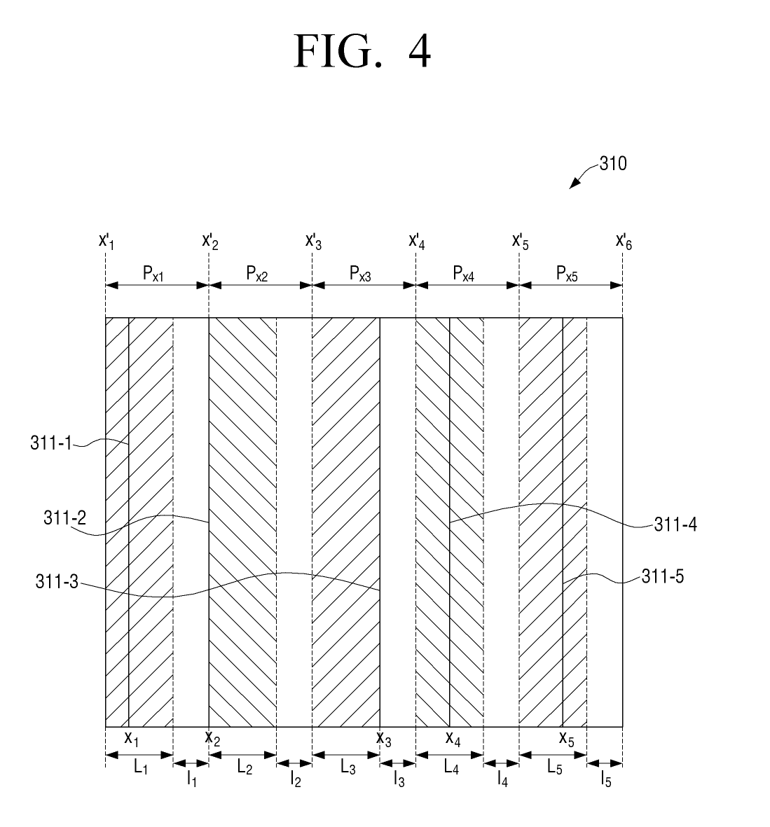

FIG. 4 is a view illustrating the plurality of first electrode lines 311-1 through 311-n that are formed at irregular intervals on the first conductive substrate 310, according to an exemplary embodiment.

According to an existing art, a plurality of first electrode lines 311-1 through 311-5 may be formed at regular intervals on a first conductive substrate 310 based on Equation 5 below.

xₙ={(2*n−1)/2}*Pₓ (Equation 5)

For example, if a period Pₓ is 100 μm, the first electrode line 311-1 of the plurality of first electrode lines 311-1 through 311-5 may be formed at x′₁ corresponding to x coordinate value 50, and the other first electrode lines 311-2 through 311-5 may be respectively formed at x′₂ through x′₅ respectively corresponding to x coordinate values 150 μm, 250 μm, 350 μm, and 450 μm. If the plurality of first electrode lines 311-1 through 311-5 are formed at regular intervals (100 μm) on the first conductive substrate 310 through a metal mesh method, an interference phenomenon occurs due to the plurality of first electrode lines 311-1 through 311-5 and thus causes a diffraction phenomenon and a Moire phenomenon which is indicated by a rainbow shape.

In order to resolve the diffraction phenomenon and the Moire phenomenon, the plurality of first electrode lines 311-1 through 311-5 may be formed at irregular intervals on the first conductive substrate 310 as shown in FIG. 4. Here, the plurality of first electrode lines 311-1 through 311-5 may be respectively formed in first through fifth cell areas that are preset based on Equation 1 above, and the first through the fifth cell areas may respectively have lengths L₁˜L₅ that are the same. Also, the first through fifth cell areas may be respectively formed within preset periods Pₓ₁˜Pₓ₅.

For example, the period Pₓ may be 100 μm, and the lengths L₁ through L₅ of the first through fifth cell areas may be each 80 μm. In this case, value X for keeping minimum intervals of the plurality of first electrode lines 311-1 through 311-5 may be calculated based on Equation 3 described above, and the calculated value X may be 0.8. Here, the value X for keeping the minimum intervals of the plurality of first electrode lines 311-1 through 311-5 may be one of intervals l₁ through l₅ between the first through fifth cell areas as shown in FIG. 4. If the value X is calculated, the plurality of first electrode lines 311-1 through 311-5 may be respectively formed at irregular intervals on the first conductive substrate 310 based on Equation 1 described above.

The x coordinate value x₁ at which the first electrode line 311-1 will be formed may be determined between 50 μm (Uₙ=0) and 130 μm (Uₙ=1) according to the random value Uₙ of Equation 1 above. The x coordinate value x₂ of the first electrode line 311-2 may be determine between 150 μm (Uₙ=0) and 230 μm (Uₙ=1). The x coordinate value x₃ of the first electrode line 311-3 may be determined between 250 μm (Uₙ=0) and 330 μm (Uₙ=1). The x coordinate value x₄ of the first electrode line 311-4 may be determined between 350 μm (Uₙ=0) and 430 μm (Uₙ=1). The x coordinate value x₅ of the first electrode line 311-5 may be determined between 450 μm (Uₙ=0) and 530 μm (Uₙ=1).

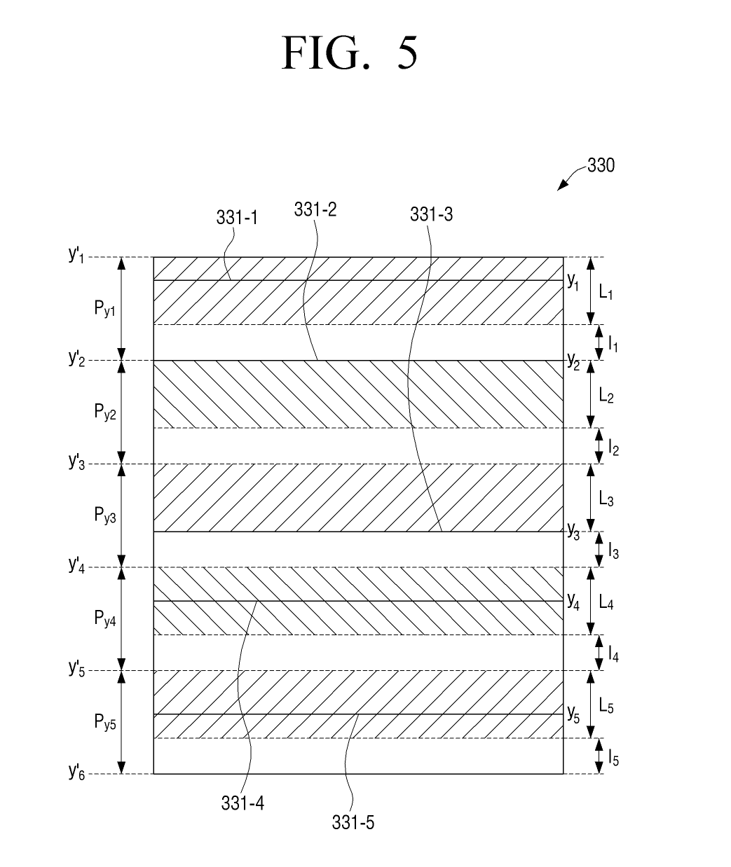

FIG. 5 is a view illustrating a plurality of second electrode lines that are formed at irregular intervals on a second conductive substrate, according to an exemplary embodiment.

As shown in FIG. 5, a plurality of second electrode lines 331-1 through 331-5 may be respectively formed at irregular intervals on a second conductive substrate 330. Here, the plurality of second electrode lines 331-1 through 331-5 may be respectively formed in preset first through fifth cell areas based on Equation 2 above, and the first through fifth cell areas may respectively have lengths L₁ through L₅. Also, the first through fifth cell areas may be respectively formed within preset periods P_{y1} through P_{y5}.

For example, the period P_{y} may be 100 μm, and the lengths L₁ through L₅ of the first through fifth cell areas may be each 80 μm. In this case, value Y for keeping minimum intervals of the plurality of second electrode lines 331-1 through 331-5 may be calculated based on Equation 4 above, and the calculated value Y may be 0.8. Here, the value Y for keeping the minimum intervals of the plurality of second electrode lines 331-1 through 331-5 may be one of intervals l₁ through l₅ between the first through fifth cell areas as shown in FIG. 5. If the value Y is calculated, the plurality of second electrode lines 331-1 through 331-5 may be formed at irregular intervals on the second conductive substrate 330 based on Equation 2 above.

According to the random value Uₙ of Equation 2 above, the y coordinate value y₁ at which the second electrode line 331-1 will be formed may be determined between 50 μm (Uₙ=0) and 130 μm (Uₙ=1). The y coordinate value y₂ of the second electrode line 331-2 may be determined between 150 μm (Uₙ=0) and 230 μm (Uₙ=1). The y coordinate value y₃ of the second electrode line 331-3 may be determined between 250 μm (Uₙ=0) and 330 μm (Uₙ=1). The y coordinate value y₄ of the second electrode line 331-4 may be determined between 350 μm (Uₙ=0) and 430 μm (Uₙ=1). The y coordinate value y₅ of the second electrode line 331-5 may be determined between 450 μm (Uₙ=0) and 530 μm (Uₙ=1).

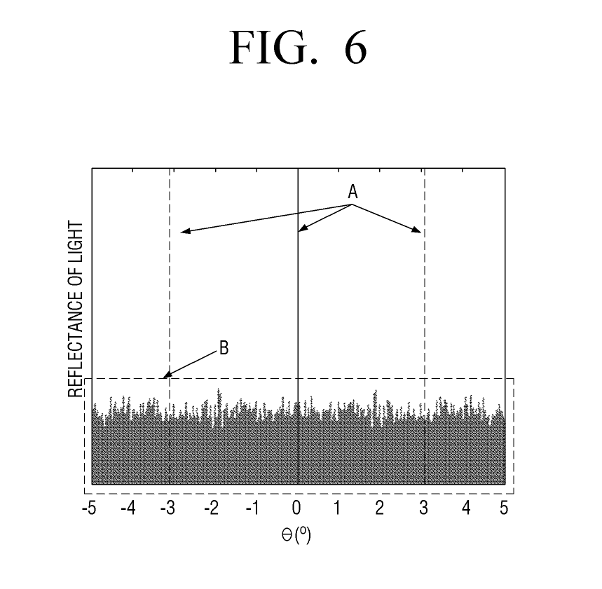

If the plurality of first electrode lines 311-1 through 311-n and the plurality of second electrode lines 331-1 through 331-n are respectively formed at the irregular intervals on the first conductive substrate 310 and the second conductive substrate 330 as described above, a diffraction phenomenon and a Moire phenomenon caused by an interference phenomenon of light may be resolved as shown in FIG. 6.

FIG. 6 is a graph illustrating a simulation result indicating a reflectance of light occurring due to a plurality of electrode lines on a touch panel, according to an exemplary embodiment.

As shown with respect to reference character A of FIG. 6, if the plurality of first electrode lines 311-1 through 311-n and the plurality of second electrode lines 331-1 through 331-n are formed at regular intervals and regular periods on the first conductive substrate 310 and the second conductive substrate 330, a reflectance of light is increased at a particular angle. In other words, if the angle is 0°, the reflectance of the light is high at the same angle. Therefore, colors of respective wavelengths are mixed to be seen in a white color. If the angle is −3° or 3°, the reflectance of the light is high at a surrounding angle. Therefore, the colors of the respective wavelengths are separated from one another, and thus a diffraction phenomenon and a Moire phenomenon indicating respective colors, i.e., a rainbow shape, occur.

In other words, according to the existing art, if the plurality of first electrode lines 311-1 through 311-n and the plurality of second electrode lines 331-1 through 331-n are formed at regular intervals and regular periods on the first conductive substrate 310 and the second conductive substrate 330, a diffraction phenomenon and a Moire phenomenon occur at a particular angle according to a wavelength of light reflected by a plurality of electrode lines.

As shown with reference character B of FIG. 6, if the plurality first electrode lines 311-1 through 311-n and the plurality of second electrode lines 331-1 through 331-n are respectively formed at irregular intervals on the first conductive substrate 310 and the second conductive substrate 330 of the touch panel 40, reflectance of light occurs at all angles. However, a size of the reflectance is much lower than an existing electrode line pattern method. If the plurality of first electrode lines 311-1 through 311-n and the plurality of second electrode lines 331-1 through 331-n are formed at irregular intervals on the first conductive substrates 310 and the second conductive substrate 330 of the touch panel 40, the reflectance of the light occurs at all angles. Therefore, colors of respective wavelengths are mixed so as to be seen in a white color, but are separated from one another to resolve a diffraction phenomenon and a Moire phenomenon which would create a rainbow shape.

A method of manufacturing the touch panel 40 according to an exemplary embodiment will now be described in detail.

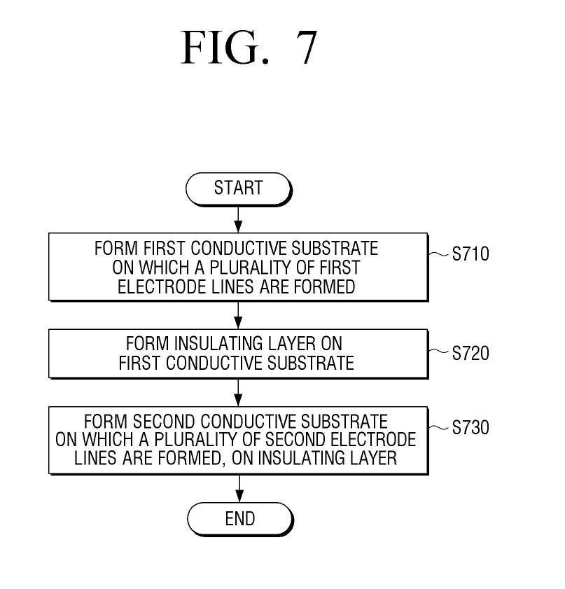

FIG. 7 is a flowchart of a method of manufacturing the touch panel 40, according to an exemplary embodiment.

Prior to the description of the method, the exemplary embodiment provides a technology for preventing a diffraction phenomenon and a Moire phenomenon caused by preset electrode patterns by changing only the electrode patterns without changing a circuit configuration of the touch panel 40. Therefore, in the exemplary embodiment, a method of forming electrode patterns of the touch panel 40 will be described in detail.

Referring to FIG. 7, in operation S710, a first conductive substrate on which a plurality of first electrode lines are formed is formed. In operation S720, an insulating layer is formed on a lower surface of the first conductive substrate on which the plurality of first electrode lines are formed. In operation S730, a second conductive substrate on which a plurality of second electrode lines are formed is formed.

Here, the plurality of first electrode lines may be respectively formed in a first area that is set to keep intervals between the plurality of first electrode lines irregular, and the plurality of second electrode lines may be respectively formed in a second area that is set to keep intervals between the plurality of second electrode lines irregular. Here, the first electrode lines that are formed at the irregular intervals on the first conductive substrate and the second electrode lines that are formed at the irregular intervals on the second conductive substrate may be formed of at least one metal material of Au, Ag, Cu, Al, Sn, Ni, Cr, Ti, Mo, Zn, and Fe or an alloy including them. The plurality of first electrode lines and the plurality of second electrode lines may be formed on the first conductive substrate 310 and the second conductive substrate 330, respectively, through a metal mesh method.

The first and second areas in which the plurality of first electrode lines and the plurality of second electrode lines are formed may be formed within periods at which the plurality of first electrode lines and the plurality of second electrode lines are formed at regular intervals. An average interval of each of the plurality of first electrode lines formed at the irregular intervals on the first conductive substrate may correspond to the period at which the plurality of first electrode lines have regular intervals on the first conductive substrate. An average interval of each of the plurality of second electrode lines formed at the irregular intervals on the second conductive substrate may correspond to the period at which the plurality of second electrode lines have regular intervals on the second conductive substrate.

The plurality of first electrode lines and the plurality of second electrode lines may be formed at the irregular intervals on the first and second conductive substrates according to coordinate values that are set based on Equations 1 through 4 as described above.

As described above, in the touch panel 40 according to the exemplary embodiment, the plurality of first electrode lines and the plurality of second electrode lines may be formed at the irregular intervals on the first and second conductive substrates without changing a design of a circuit configuration for detecting variations in a capacitance caused by a touch input made by a user. Therefore, a diffraction phenomenon and a Moire phenomenon may be avoided.

According to various exemplary embodiments as described above, a touch panel may resolve a diffraction phenomenon and a Moire phenomenon caused by preset electrode patterns by changing the electrode patterns without changing a design of the circuit configuration or requiring an additional circuit configuration.

The foregoing exemplary embodiments are merely exemplary and are not to be construed as limiting. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A touch panel comprising:
a first conductive substrate configured to form a plurality of first electrode lines on the first conductive substrate; and
a second conductive substrate configured to form a plurality of second electrode lines in a direction crossing the plurality of first electrode lines on the second conductive substrate,
wherein the plurality of first electrode lines are respectively formed in a first area that is set to keep intervals between the plurality of first electrode lines irregular, and the plurality of second electrode lines are respectively formed in a second area that is set to keep intervals between the plurality of second electrode lines irregular.

2. The touch panel of claim 1, wherein the first area and the second area are areas that are set within periods at which the plurality of first electrode lines and the plurality of second electrode lines have regular intervals.

3. The touch panel of claim 2, wherein an average interval of the plurality of first electrode lines and an average interval of the plurality of second electrode lines correspond to the periods at which the plurality of first electrode lines and the plurality of second electrode lines, respectively, have the regular intervals.

4. The touch panel of claim 1, wherein the plurality of first electrode lines are formed in the first area based on coordinate values calculated from Equation 1 and wherein the plurality of second electrode lines are formed in the second area based on coordinate values calculated from Equation 2:
xₙ={(2*n−1)/2}*Pₓ+X*Px*Uₙ [Equation 1]
yₙ={(2*n−1)/2}*P_{y}+Y*P_{y}*Uₙ [Equation 2]
wherein n denotes an index value of each of the first electrode lines and the second electrode lines, Pₓ and P_{y} denote periods having regular intervals, X and Y denote values that are set to keep minimum intervals of the plurality of first electrode lines and the plurality of second electrode lines, respectively, and Uₙ denotes a random value between 0 and 1.

5. The touch panel of claim 4, wherein the values X and Y that are set to keep the minimum intervals of the plurality of first electrode lines and the plurality of second electrode lines, respectively, are calculated from Equation 3 and Equation 4, respectively:
X=L/Pₓ [Equation 3]
Y=L/P_{y} [Equation 4]
wherein L in Equation 3 denotes a length value of the first area, and wherein L in Equation 4 denotes a length value of the second area.

6. The touch panel of claim 1, wherein the plurality of first electrode lines and the plurality of second electrode lines are formed on the first conductive substrate and the second conductive substrate, respectively, through a metal mesh method.

7. The touch panel of claim 1, wherein the plurality of first electrode lines and the plurality of second electrode lines are respectively formed of at least one metal material of gold (Au), silver (Ag), copper (Cu), aluminum (Al), tin (Sn), nickel (Ni), chrome (Cr), titanium (Ti), molybdenum (Mo), zinc (Zn), and iron (Fe) or an alloy comprising at least one of Au, Ag, Cu, Al, Sn, Ni, Cr, Ti, Mo, Zn, and Fe.

8. A method of manufacturing a touch panel, the method comprising:
forming a first conductive substrate on which a plurality of first electrode lines are formed on the first conductive substrate; and
stacking a second conductive substrate on which a plurality of second electrode lines are formed in a direction crossing the plurality of first electrode lines,
wherein the plurality of first electrode lines are respectively formed in a first area that is set to keep intervals between the plurality of first electrode lines irregular, and the plurality of second electrode lines are respectively formed in a second area that is set to keep intervals between the plurality of second electrode lines irregular.

9. The method of claim 8, wherein the first area and the second area are areas that are set within periods at which the plurality of first electrode lines and the plurality of second electrode lines, respectively, have regular intervals.

10. The method of claim 9, wherein an average interval of the plurality of first electrode lines and an average interval of the plurality of second electrode lines correspond to the periods at which the plurality of first electrode lines and the plurality of second electrode lines, respectively, have the regular intervals.

11. The method of claim 8, wherein the plurality of first electrode lines are formed in the first area based on coordinate values calculated from Equation 1, and wherein the plurality of second electrode lines are formed in the second area based on coordinate values calculated from Equation 2:
xₙ={(2*n−1)/2}*Pₓ+X*Px*Uₙ [Equation 1]
yₙ={(2*n−1)/2}*P_{y}+Y*P_{y}*Uₙ [Equation 2]
wherein n denotes an index value of each of the first electrode lines and the second electrode lines, Pₓ and P_{y} denote periods having regular intervals, X and Y denote values that are set to keep minimum intervals of the plurality of first electrode lines and the plurality of second electrode lines, respectively, and Uₙ denotes a random value between 0 and 1.

12. The method of claim 11, wherein the values X and Y that are set to keep the minimum intervals of the plurality of first electrode lines and the plurality of second electrode lines, respectively, are calculated from Equation 3 and Equation 4, respectively:
X=L/Pₓ [Equation 3]
Y=L/P_{y} [Equation 4]
wherein L in Equation 3 denotes a length value of the first area, and wherein L in Equation 4 denotes a length value of the second area.

13. The method of claim 8, wherein the plurality of first electrode lines and the plurality of second electrode lines are formed on the first conductive substrate and the second conductive substrate, respectively, through a metal mesh method.

14. The method of claim 8, wherein the plurality of first electrode lines and the plurality of second electrode lines are respectively formed of at least one metal material of gold (Au), silver (Ag), copper (Cu), aluminum (Al), tin (Sn), nickel (Ni), chrome (Cr), titanium (Ti), molybdenum (Mo), zinc (Zn), and iron (Fe) or an alloy comprising at least one of Au, Ag, Cu, Al, Sn, Ni, Cr, Ti, Mo, Zn, and Fe.

15. A touch display panel, comprising:
a first conductive substrate comprising a plurality of first electrode lines, wherein the plurality of first electrode lines are formed at irregular intervals on the first conductive substrate; and
a second conductive substrate comprising a plurality of second electrode lines, wherein the plurality of second electrode lines are formed at irregular intervals on the second conductive substrate,
wherein the plurality of first electrode lines are formed in a different direction than the plurality of second electrode lines.
